(19) United States
(12) Patent Application Publication
(10) Pub. No.: US 2025/0001464 A1
(43) Pub. Date: Jan. 2, 2025

(54) Multi-Unit Pressure Washer System with Y-Manifold

(71) Applicant: Mr. Diesel Repair, LLC, Justin, TX (US)

(72) Inventor: Austin Gene Eguires, Justin, TX (US)

(73) Assignee: Mr. Diesel Repair, LLC, Justin, TX (US)

(21) Appl. No.: 18/747,554

(22) Filed: Jun. 19, 2024

Related U.S. Application Data
(60) Provisional application No. 63/511,026, filed on Jun. 29, 2023.

(51) Int. Cl. B08B 3/02

(52) U.S. Cl. CPC B08B 3/026

(57) ABSTRACT

A Y-shaped manifold system connects two or more pressure washer units, joining the two or more flows therefrom. The Y-manifold system has a manifold body with a converging channel that connects two inlet ports to an outlet port via inlet channels and a merged channel. The inlet channels are separated by the spread angle, which is centered on the alignment of the outlet channel. The inlet ports are separated from an inlet centerline by a convergence angle. The Y-manifold system includes intake sections with check valves and couplers for hoses, the manifold body, and an output section.

### BACKGROUND OF THE INVENTION

The pressure washing industry uses pumps to provide a high flow of highly-pressurized water to wash surfaces using an applicator to apply the water. A higher flow rate (typically described in GPM) is cost effective by minimizing work time. High GPM pressure washer units (PWU) are substantially more expensive than lower GPM PWUs, however, because they have bigger engines and pumps. Smaller PWUs cost less because of their smaller engines and pumps. Joining two (or more) smaller PWUs in parallel can provide a higher GPM. The flow rates are additive, thus, combining two 4 GPM PWUs doubles the flow rate to get an overall 8 GPM, or combining two 5.5 GPM PWUs to total an output of 11 GPM, with the commonly-used 3/8″ pressure washer hose.

A problem with running two or more PWUs in parallel is that where the flows joins is commonly a T-shaped joint or high-pressure fitting, where each PWU supplies one of the upper arms of the “T” and the output exits at the bottom. This T-fitting limits the flow because the two flows from the PWUs are opposing each other flowing through the T-fitting and are thus meeting at a 180-degree angle. This has, in addition, the effect of causing additional wear on the PWUs due to the opposing flows.

Accordingly, a Y-shaped manifold system connects two or more PWUs to increase the efficiency and maximum flow by causing the flows to converge at a low angle while providing sufficient separation of the ports for proper attachment of the fittings.

### BRIEF STATEMENT OF THE INVENTION

A Y-manifold joins two flows coming from separate PWUs at a 30-degree angle; this angle could be less or more, such as about 30-degrees, about 20-degrees, or about 45-degrees. This enables the pumps not to block or oppose each other. Instead, the flows are merging and even pulling together. In addition, if one PWU pump is stronger pump, that PWUs flow may draw the weaker pump's flow to create sufficient pressure and consistent flow (similar to a venturi effect).

In an embodiment, a Y-shaped manifold system joins two water flows coming from separate PWUs at a 30-degree spread angle; this spread angle could be less or more, such as about 30-degrees, about 20-degrees, or about 45-degrees. The Y-manifold system includes a converging channel that connects two inlet ports to an outlet port via inlet channels and a merged channel. The inlet channels are separated by the spread angle, which is centered on the alignment of the outlet channel.

### BRIEF DESCRIPTION OF THE FIGURES

FIG. 1 is a schematic showing an embodiment of a pressure washer system with a Y-manifold of the present invention.

FIG. 2 shows a top view of a portion of an embodiment of a pressure washer system with a Y-manifold of the present invention.

FIGS. 3A, 3B, and 3C show, respectively, top, front, and rear views of an embodiment of a manifold body of the present invention.

FIG. 3D shows a section view along line A-A from FIG. 3B.

FIG. 4 shows a top, rear left oblique view of the manifold body of FIG. 3A.

### DETAILED DESCRIPTION OF THE INVENTION

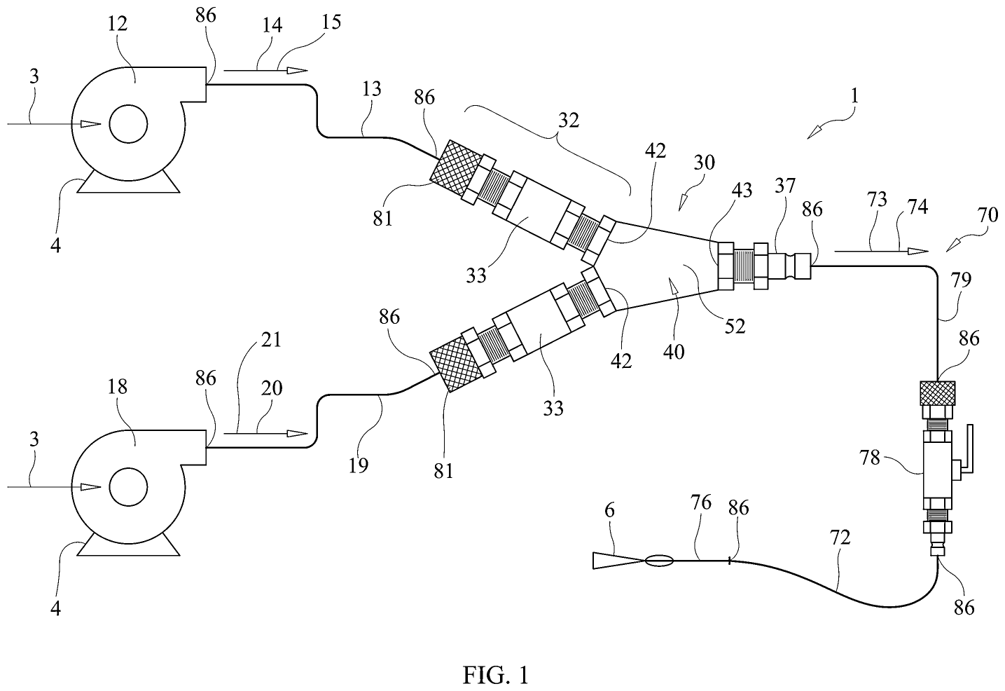

For a first embodiment, we refer to FIG. 1.

In a first embodiment, pressure washing system 1 uses water sources 3, power source 4 and creates washing spray 6 that is pressurized water. Pressure washing system 1 includes flow input section 10, Y-manifold system 30, and flow output section 70.

Flow input section 10 includes first PWU 12 connected to water source 3 and power source 4, and connected to hose end 86 of pressure washer supply hose 13 at its output fitting. First PWU 12 creates water flow 14 at pressure 24 and at supply flow rate 15. In an embodiment, flow rate 15 is 4 GPM and pressure 24 is 4000 psi. Flow input section 10 includes second PWU 18 connected to water source 3 and power source 4, and connected to hose end 86 of pressure washer supply hose 19 at its output fitting. Second PWU 18 creates water flow 20 at pressure 24 and at supply flow rate 21. In an embodiment, flow rate 21 is also 4 GPM and pressure 24 is also 4000 psi.

Y-manifold system 30 includes intake sections 32, manifold body 40, and output section 37. Intake sections 32 include female coupler (quick disconnect fitting) 81 for connecting to hose ends 86 of pressure washer supply hose 13 and pressure washer supply hose 19 to supply water flow 14 and supply water flow 20 to Y-manifold system 30. Intake sections 32 also include check valve 33 to prevent backflow between PWU 12 and PWU 18. Check valves 33 connect to inlet ports 42 of Y-manifold system 30. Check valves 33 thus operate to create one-way flow 34 into Y-manifold system 30 by preventing water from entering from one pressure washer supply hose and leaving by the other (typically experienced during startup or other times when one PWU is not operating). Manifold body 40 is Y-shaped and includes inlet ports 42 on the upper arms of the ‘Y’ and outlet port 43 on the bottom of the ‘Y’. Converging channel 52 connects both inlet ports 42 to the single outlet port 43, and converges at an angle of about 20-degrees, about 30-degrees, or about 45-degrees. This causes flow at outlet port 43 to be the combined (merged) flow of water flow 14 and water flow 20 resulting in service water flow 73 at service flow rate 74. In an embodiment, service flow rate 74 is 8 GPM and pressure 24 is 4000 psi. Outlet port 43 connects to output section 37, for connecting manifold body 40, and Y-manifold system 30, to flow output section 70. In an embodiment, service flow rate 74 is 8 GPM and pressure 24 is 4000 psi. Outlet port 43 connects to output section 37, for connecting manifold body 40, and Y-manifold system 30, to flow output section 70.

In an embodiment, supply flow rate 15 and supply flow rate 21 are each above 5.5 GPM and service flow rate 74 is about twice that and above 11 GPM. In an embodiment, supply flow rate 15 and supply flow rate 21 are each about 6 GPM and service flow rate 74 is about 12 GPM. In an embodiment, supply flow rate 15 and supply flow rate 21 are each about 8 GPM and service flow rate 74 is about 16 GPM. In an embodiment, service flow rate 74 is about 10-20 GPM, about 12-20 GPM, about 16-20 GPM, about 18-24 GPM, or about 12-30 GPM.

Flow output section 70 includes jumper hose 79 (connected to output section 37 at hose end 86) and pressure washer service hose 72, connected by ball valve 78 therebetween at hose ends 86, and applicator 76 attached at the terminal at hose end 86 of pressure washer service hose 72. Jumper hose 79 may be short, such as 15 feet; pressure washer service hose 72 is long, but no longer than 200 feet.

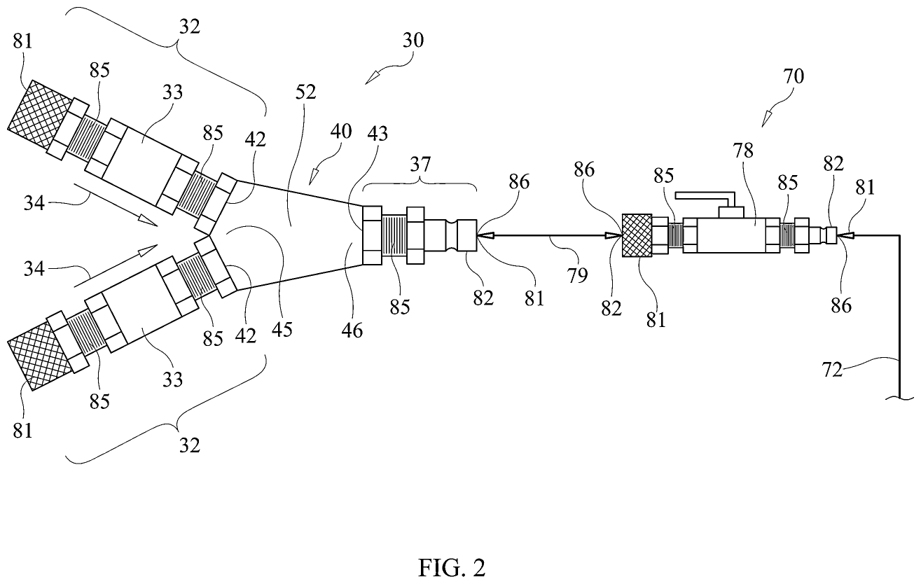

For a second embodiment, we refer to FIG. 2, showing Y-manifold system 30, and a portion of flow output section 70.

In a second embodiment, Y-manifold system 30 includes intake sections 32, manifold body 40, and output section 37. Intake sections 32 include female coupler (quick disconnect fitting) 81 for connecting to hose ends 86 of pressure washer supply hose 13 and pressure washer supply hose 19 to supply water flow 14 and supply water flow 20 to Y-manifold system 30. Female coupler 81 is connected by NPT connector 85 to check valve 33 to prevent backflow. Check valves 33 connect to inlet ports 42 of Y-manifold system 30 by NPT connector 85. Check valves 33 thus operate to create one-way flow 34 into Y-manifold system 30. Manifold body 40 is Y-shaped and includes inlet ports 42 on the upper arms of the ‘Y’ at inlet end 45 and outlet port 43 on the bottom of the ‘Y’ on outlet end 46. Converging channel 52 connects both inlet ports 42 to outlet port 43, and converges from said inlet ports 42 to said outlet port 43 at an angle of about 20-degrees, about 30-degrees, or about 45-degrees. This causes flow at outlet port 43 to be the combined flow of water entering inlet ports 42 resulting in a higher, combined, water flow rate. Outlet port 43 connects to output section 37 via NPT connector 85. Output section 37 includes NPT connector 85, which is connected to male plug (quick disconnect fitting) 82, for connecting manifold body 40, and Y-manifold system 30, to flow output section 70.

Flow output section 70 includes jumper hose 79, pressure washer service hose 72, and ball valve 78. Jumper hose 79 is connected to output section 37 at hose end 86 via female coupler (quick disconnect fitting) 81 and is connected to ball valve 78 at hose end 86 via male plug (quick disconnect fitting) 82. Ball valve 78 is connected to jumper hose 79 via female coupler (quick disconnect fitting) 81 and includes male plug (quick disconnect fitting) 82 at its other end for connection to hose end 86 of pressure washer service hose 72.

The system of FIG. 2 can be hooked up as part of pressure washing system 1 as shown in FIG. 1.

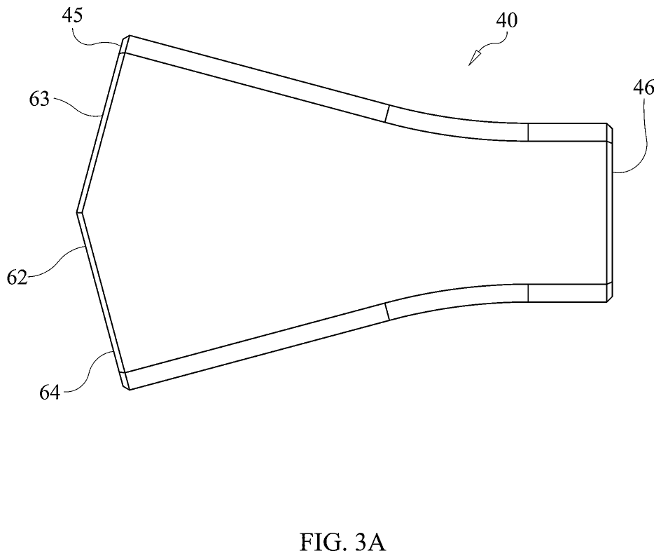

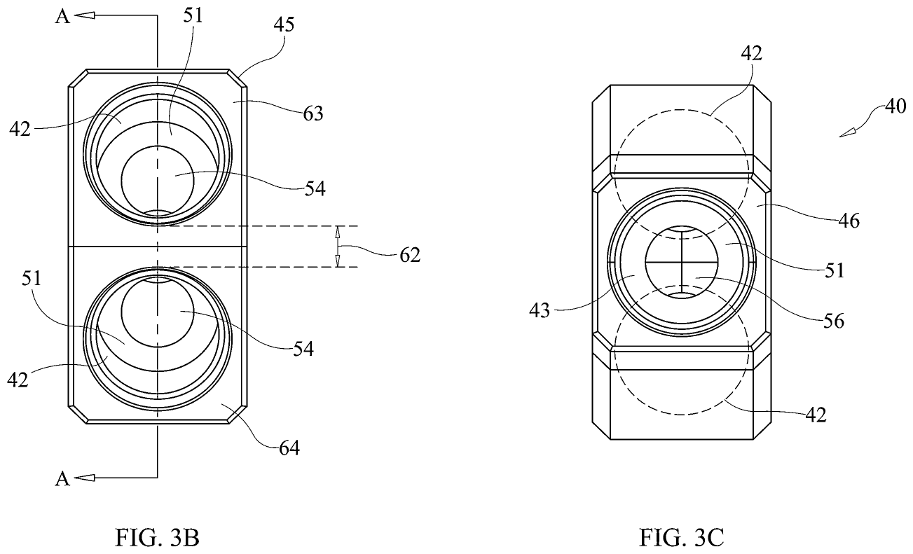

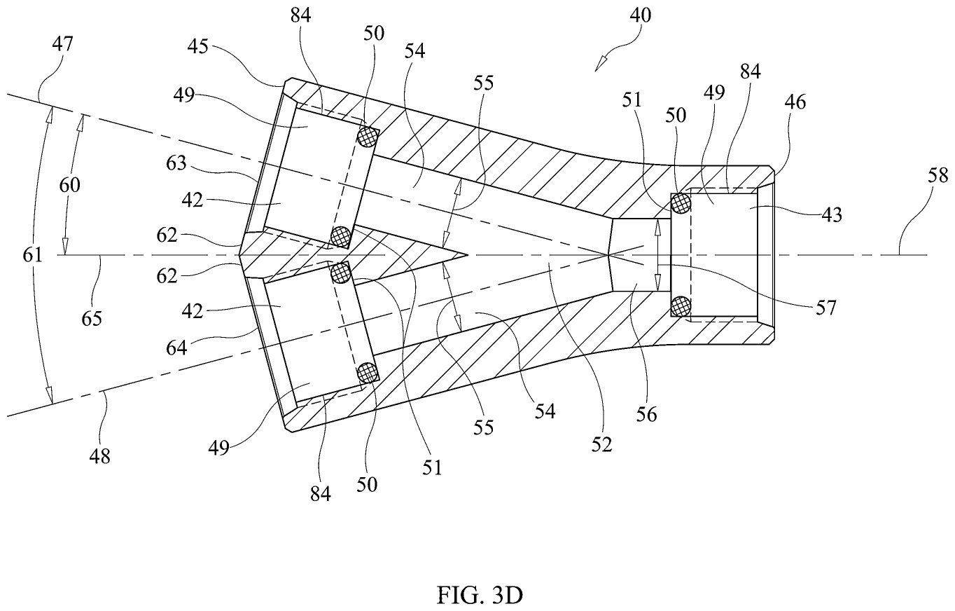

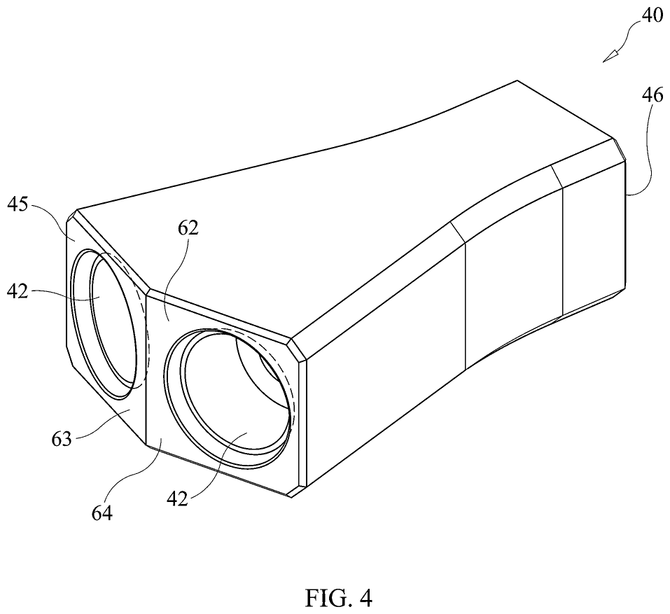

For a third embodiment, we refer generally to FIGS. 3A-3D & 4.

In a third embodiment, manifold body 40 includes inlet ports 42 at inlet end 45, outlet port 43 at outlet end 46, and converging channel 52 connecting inlet ports 42 to outlet port 43.

Converging channel 52 includes inlet channels 54, each having diameter 55 and centerlines 47 and 48. Inlet channel 54 connecting to first inlet port 42 has centerline 47; inlet channel 54 connecting to second inlet port 42 has centerline 48 which is separated from centerline 47 by spread angle 61. Spread angle 61 is centered on the alignment of outlet channel, outlet centerline 58. Spread angle 61 may be about 20-degrees, about 30-degrees, or about 45-degrees. Midway between centerlines 47 and 48 is inlet centerline 65; the angle between centerline 47 and inlet centerline 65 is convergence angle 60 and the angle between centerline 48 and inlet centerline 65 is convergence angle 60, which may be the same. Convergence angle 60 may be about 10-degrees, about 15-degrees, or about 22.5-degrees. Inlet centerline 65 may be collinear with outlet centerline 58, in which case the angle between centerline 47 and outlet centerline 58 is convergence angle 60 and the angle between centerline 48 and outlet centerline 58 is convergence angle 60, which may be the same. Converging channel 52 includes merged channel 56 along outlet centerline 58, where merged channel has diameter 57 and is the joined channel formed by inlet channels 54 at spread angle 61. Merged channel 56 connects to outlet port 43.

Inlet channels 54 are fluidically connected, one each, to inlet ports 42, and permit the combined water flow from inlet ports 43 to reach merged channel 56 via converging channel 52. Merged channel 56 is fluidically connected to outlet port 43. Water flow 14 and water flow 20, via inlet ports 42, thus feed into inlet channels 54 which water then feeds into converging channel 42 and which water then feeds into merged channel 56 and then outlet port 43 as service water flow 73. Converging channel 56 merges water flow 14 (with supply flow rate 15) and water flow 20 (with supply flow rate 21) into service water flow 73 (with combined service flow rate 74). Converging channel 56 merges water flows at spread angle 61 (typically double convergence angle 60).

Inlet end 45 includes inlet face 63 (with first inlet port 42 formed therethrough along centerline 47) and inlet face 43 (with second inlet port 42 formed therethrough along centerline 48), where inlet face 63 is angled away from inlet face 64 by spread angle 61, and inlet ports 42 are separated from one another by port separation 62 (to provide space for fittings). If inlet ports 43 and outlet port 43 are aligned, respectively, to inlet channels 54 and merged channel 56, then one can assign those centerlines to the ports. Inlet ports 42 include cylinder (void) 49 with internal threads 88 (for NPT connector 85). Inlet ports 42 also include O-ring boss 51 at the inner end of cylinder 49 where it connects to inlet channel 54, and O-ring 50 (only shown on FIG. 3D).

Outlet end 46 includes outlet port 43 formed therethrough along centerline 58. Outlet port 43 includes cylinder (void) 49 with internal threads 88 (for NPT connector 85). Outlet port 43 also includes O-ring boss 51 at the inner end of cylinder 49 where it connects to merged channel 56, and O-ring 50 (only shown on FIG. 3D).

Inlet ports 42 are thus connected by inlet channels 54, converging channel 52, merged channel 56 to outlet port 43, permitting water flow 20 from both PWUs 12 and 18 to be combined into service water flow 73 (see FIG. 1).

The system of FIGS. 3A-3D & 4 can be hooked up as part of pressure washing system 1 as shown in FIG. 1 and Y-manifold system 30 as shown in FIG. 2.

The manifold body may be made of a solid block of 304 grade stainless steel by using a 5-axis CNC machine. Stainless steel is used to avoid corrosion that would occur with ordinary steel or aluminum. Brass or copper are too soft to handle the high water pressure. Carbon fiber is very expensive to manufacture.

Connections between sections may be made using standard high-pressure fittings, such as male and female NPT fittings to connect parts as well as male and female quick-connect fittings as are typically used for powerwashing and high-pressure systems. Fittings are commonly ⅜″ for connections and hoses but could also be ½″ for increased flow rates, which might require using a lower convergence angle.

In a fourth embodiment, not shown here, the Y-manifold system is a triple-Y, having three different ports joining together in a 3-way converging channel; this convergence could be flat (i.e. in a plane) or 3D. In the 3D embodiment, each inlet channel is the same or substantially the same angle from one another and has substantially the same convergence angle from an inlet centerline (like the lines forming the top of a triangular pyramid).

A method of combining water flows from two PWUs includes:

200 Setting two PWUs to the same pressure.

210 Connecting a Y-manifold system to supply hoses connected to PWU 1 & PWU 2. 220 Connecting a PWU 1 hose end to a first inlet port on the Y-manifold system.

225 Connecting a PWU 2 hose end to a second inlet port on the Y-manifold system.

230 Connecting a service hose having a ball valve thereon to an outlet port of the Y-manifold system.

240 Opening the ball valve.

250 Starting PWU 1.

255 Starting PWU 2.

260 Closing the ball valve on the service hose.

270 Attaching applicators such as pressure washer gun or surface cleaner.

280 Providing the combined water flow of PWU 1 & 2 to the service hose.

A method of providing water flows from a plurality of PWUs to a service hose includes:

300 Connecting a plurality of PWUs to the Y-manifold system via supply hoses connected to a plurality of inlet ports on the Y-manifold system.

310 Connecting a pair of supply hoses to a pair of inlet ports.

320 Connecting a service hose to an outlet port on the Y-manifold system.

330 Providing water from the PWUs into the inlet ports on the Y-manifold system,

the inlet ports connected to the outlet port by a converging channel.

1. A multi-unit pressure washer system, comprising:
a plurality of pressure-washing units;
a manifold system;
the manifold system comprising:
a plurality of inlet ports;
an outlet port; and
a converging channel;
said converging channel connecting said plurality of inlet ports to said outlet port; and
said converging channel converging at low angle.

2. The pressure washer system of claim 1, said converging channel converging at an angle, the angle selected from a group consisting of about 20 degrees and about 30 degrees.

3. The pressure washer system of claim 1, further comprising:
said plurality of inlet ports each having an inlet port centerline;
a spread angle between the inlet port centerlines, the spread angle selected from a group consisting of about 20 degrees and about 30 degrees.

4. The pressure washer system of claim 1, further comprising:
said plurality of inlet ports each having an inlet port centerline;
an inlet centerline midway between said inlet port centerlines; and
a convergence angle between at least one of said inlet port centerlines and said inlet centerline, the convergence angle selected from a group consisting of about 10 degrees and about 15 degrees.

5. The pressure washer system of claim 1,
said converging channel comprising a plurality of inlet channels and a merged channel;
each of said inlet channels connected to one each of said plurality of said inlet ports; and
said merged channel connected to said outlet port.

6. The pressure washer system of claim 5, further comprising:
said plurality of inlet channels each having an inlet channel centerline;
said merged channel having a centerline; and
a convergence angle between at least one of said inlet channel centerlines and said merged channel centerline, the convergence angle selected from a group consisting of about 10 degrees and about 15 degrees.

7. The pressure washer system of claim 1, the manifold system further comprising:
two inlet ports;
two inlet channels; and
a merged channel;
the inlet ports each feeding into one of the inlet channels;
each inlet channel feeding into said merged channel; and
said merged channel feeding into said outlet port.

8. The pressure washer system of claim 8, further comprising:
two pressure washing units; and
a flow output section;
each of said pressure washing units connected to one of said plurality of inlet ports; and
said flow output section connected to said outlet port.

9. A method of combining multiple pressure washer units for a pressure washer system, comprising:
connecting a plurality of pressure washer units to a plurality of inlet ports on a manifold system;
connecting the inlet ports to an outlet port on said a manifold system via a converging channel;
said converging channel converging at low angle.

10. The method of claim 9, further comprising:
providing water flow from the pressure washer units into the inlet ports on the Y-manifold system; and
delivering the water flow from the pressure washer units to the outlet port by the converging channel.

11. The method of claim 10, further comprising:
the providing water flow step comprising providing a supply water flow rate of about 6 GPM to about 10 GPM from each the pressure washer units into the inlet ports.

12. The method of claim 10, further comprising:
the delivering water flow step comprising delivering a service water flow rate of about 12 GPM to about 20 GPM to the outlet port.

13. The method of claim 10, further comprising:
providing water flow at a supply flow rate of at least about 6 GPM from each of two pressure washer units into the inlet ports on the Y-manifold system; and
delivering water flow at a service flow rate of at least about 12 GPM to the outlet port;
the delivering step comprising merging the water flow from the pressure washer units into a service water flow in said converging channel.

14. The method of claim 13, further comprising:
the delivering water step further comprising delivering water flow at a service flow rate of at least about 16 GPM to 20 GPM to the outlet port.

15. The method of claim 10, the step of connecting the inlet ports to an outlet port further comprising:
connecting each of said plurality of inlet ports to an inlet channel;
connecting said outlet port to a merged channel;
said inlet channels converging at a spread angle relative to said outlet channel, the angle selected from a group consisting of about 20 degrees and about 30 degrees.

16. The method of claim 10, the delivering the water step further comprising:
merging the water flow from each of said plurality of pressure washer units into a service water flow in said converging channel at a low angle.
